(19) United States
(12) Patent Application Publication
(10) Pub. No.: US 2012/0318890 A1
(43) Pub. Date: Dec. 20, 2012

(54) Spray Gun

(76) Inventor: Timothy George Hopper, Guildford (GB)

(21) Appl. No.: 13/470,433

(22) Filed: May 14, 2012

(30) Foreign Application Priority Data
Jun. 17, 2011 (GB) 1110336.3
Sep. 2, 2011 (GB) 1115249.3

(51) Int. Cl. B05B 1/28

(52) U.S. Cl. 239/290

(57) ABSTRACT

An air spray gun operated by blowing air past a nozzle, the air drawing the spray liquid from the nozzle and imparting momentum to it. The air cap includes formations to bias air flow towards the air horns having patterning air directed to them. The central opening extends towards the air horns, either in the form of a square opening with the corners of the square closest to the horns, or in the form of a compound curved shaped providing pronounced curvature of the corners at the axes toward the horns. This significantly improves paint spray patterning and discourages paint deposition on the air horns.

### CROSS REFERENCE TO RELATED APPLICATIONS

The present application claims priority to United Kingdom Patent Application Number 1110336.3 filed on Jun. 17, 2011, currently pending. The present application further claims priority to United Kingdom Patent Application Number 1115249.3 filed on Sep. 2, 2011.

### FIELD OF THE INVENTION

The present invention relates to a spray gun, particularly though not exclusively for spraying paint.

### BACKGROUND

In this specification the term “spray liquid” is used to refer to paint or other liquid to be sprayed.

Generally spray guns are of two types, (i.) those operated by pumping the spray liquid to a nozzle whence it sprays under momentum imparted by being pumped through the nozzle and (ii.) those operated by blowing gas—usually air—past a nozzle, the air drawing the spray liquid from the nozzle and imparting momentum to it. Flow of paint can be regulated with a needle extending into the nozzle. The spray liquid may enter the nozzle at atmospheric or elevated pressure. This type of spray gun is referred to here as an “air spray gun”. Air spray guns themselves are of two further types, those operating at conventional compressed air pressure and those operating at low pressure, but with high volume flow. These are known as HVLP spray guns. The invention relates to BOTH types of air spray gun. Air spray guns can be assisted by pumping of spray liquid to them.

Typically an air spray gun comprises:
an air flow passage in the gun;
a spray liquid nozzle mounted in the air flow passage and having an orifice for spray liquid to flow from, the orifice being on the downstream side of the spray liquid nozzle with respect to both air and spray liquid flow;
a needle extending from upstream into the spray liquid nozzle for regulating its orifice and flow of the spray liquid;
a spray liquid flow passage to the spray liquid nozzle, with the needle extending in the spray liquid flow passage;
a flow-passage/needle seal at a position along the needle spaced from the spray liquid nozzle;
a trigger mechanism connected to the needle to regulate its position;
an air cap defining with the spray liquid nozzle:
   a convergent air flow region immediately upstream of the spray liquid orifice,
   a central opening from which spray liquid entraining air flows and
   at least one pair of opposed horns having spray patterning bores with orifices directed inwards for patterning the spray liquid containing air flow from the central opening and
an air distributor upstream of the air cap for distributing air to the patterning bores.

This air spray gun is referred to as being “of the type defined.”

In our British patents Nos 2,468,196 and 2,469,587 (“Our Earlier Patents”), we have described improvements in such air spray guns, particularly
provision of front loading of the needle and
provision of four air horns on the air cap as opposed to the more normal two, the four horns being set at 12 o'clock, 3 o'clock, 6 o'clock and 9 o'clock with respect to the normal orientation of the air spray gun, and adaptation of the air distributor to provide progressive changing of the spray pattern from the gun.

### SUMMARY

The object of the present invention is to further improve spray patterning.

According to the invention there is provided an air spray gun of the type defined, wherein:
the central opening in the air cap and/or the outer surface of the spray liquid nozzle, in its extent towards the central opening, and/or a central bore in the air distributor is formed, i.e. provided with formations, so as to bias air flow towards the pair of air horns or, where two pairs are provided, the one of the pair having patterning air directed to them.

In other words, means is provided for biasing air flow to and through the to central opening in the air cap towards the pair of air horns or, where two pairs are provided, the one of the pair having patterning air directed to them.

Whilst it is envisaged that a single pair of rotationally adjustable air horns only, together with a fixed air distributor, may be provided, in the preferred embodiment described below two pairs are provided, as in Our Earlier Patents, that is with the air horns being rotationally fixed and the air distributor being rotationally adjustable. The rotational adjustment is provided for changing the shape and/or the orientation of the spray pattern.

Preferably the air cap formations are spreadings of the central bore, the spreadings being diametrically aligned with the said air horns. In the preferred embodiment, the spreadings are two sided cut-outs or nicks directed towards their air horns.

Preferably the spray liquid nozzle formations are external cutaways aligned or alignable with the said air horns. In the preferred embodiment, the external cutaways are flats in the external conical surface of the nozzle. The flats could be scallops.

Preferably the air distributor bore formations are spreadings alignable with the said air horns. In the preferred embodiment, these spreadings are local, curved enlargements of the diametrical dimension of the bore. They can give the bore an elliptical shape.

Preferably, the air distributor and the spray liquid nozzle are rotationally connected whereby the nozzle cutaways and the air-distributor, bore spreadings are aligned. In the preferred embodiment, this is achieved via grooves in the nozzle and spigots on the air distributor engaging in the grooves.

The spray gun of the preferred embodiment is an HVLP air spray gun.

Additionally the provision of a pronounced radius of curvature of the formations in the air cap biases the air flow towards the air horns. Preferably the to radius of curvature is between a fourth and an eighth of that of the transverse dimension of the central opening in the direction between opposed air horns. The preferred radius of curvature is substantially one six of this dimension.

### BRIEF DESCRIPTION OF THE DRAWINGS

To help understanding of the invention, a specific embodiment thereof will now be described by way of example and with reference to the accompanying drawings, in which:

FIG. 1 is a perspective view of an air spray gun of the invention;

FIG. 2 is an elevational, cross-sectional view of the air gun of FIG. 1;

FIG. 3 is a front view of the air cap of the air gun of Our Earlier Patents;

FIG. 4 is a front view of the spray liquid nozzle of air gun of Our Earlier Patents;

FIG. 5 is a front view of the air distributor of air gun of Our Earlier Patents;

FIG. 6 is a cross-sectional perspective view from behind the air cap and spray liquid nozzle of Our Earlier Patents;

FIG. 7 is a similar cross-sectional view of the air cap and spray liquid nozzle of the air spray gun of FIG. 1, that is of the invention, the section being taken at the rear face of the air cap;

FIG. 8 is a similar cross-sectional view to that of FIG. 7, but taken slightly further back to show circumferential grooves in the air distributor;

FIG. 9 is a front view, similar to FIG. 5, of the air distributor of the air spray gun of FIG. 1;

FIG. 10 is a front view, similar to FIG. 3, of the air cap of the air spray gun of FIG. 1;

FIG. 11 is a front view, similar to FIG. 4, of the spray liquid nozzle of the air spray gun of FIG. 1;

FIG. 12 is a scrap front view of the air spray gun of FIG. 1;

FIG. 13 is a plan cross-sectional view through the air cap of the air spray gun of FIG. 1;

FIG. 14 is a scrap view as FIG. 13 of the air cap, nozzle and distributor only on a larger scale;

FIG. 15 is a similar view orthogonal to FIG. 14;

FIG. 16 is a rear perspective view of spray liquid nozzle of FIG. 11;

FIG. 17 is a diagram showing comparative spray distribution with the air guns of Our Earlier Patents and of the invention; and

FIG. 18 is view similar to FIG. 10 of an air cap having an improved, pronouncedly-curved, central opening.

### DETAILED DESCRIPTION

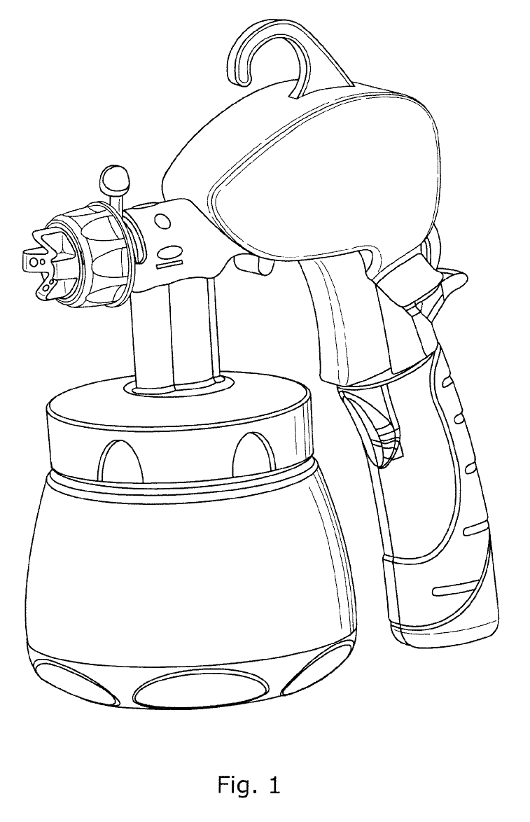

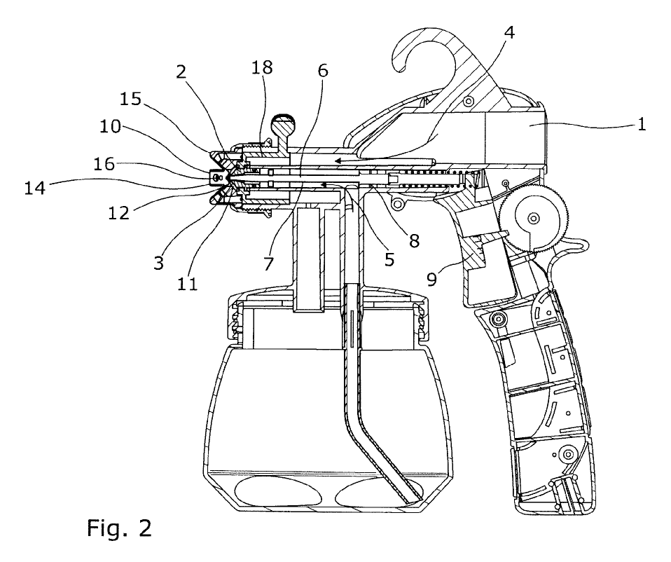

Referring to the drawings, FIG. 1 shows an air spray gun of the type defined. It is generic to Our Earlier Patents and the present invention, insofar as the parts of the present invention or at least their improvements are not visible in FIG. 1. Nor indeed are the parts identified in the above definition of type visible in FIG. 1. They are visible in FIG. 2, which is a sectional view of an air gun of the invention, as follows:
an air flow passage 1 in the gun;
a spray liquid nozzle 2 mounted in the air flow passage 1 and having an orifice 3 for spray liquid to flow from, the orifice being on the downstream side of the spray liquid nozzle with respect to both air and spray liquid flow 4,5;
a needle 6 extending from upstream into the spray liquid nozzle 2 for regulating its orifice and flow of the spray liquid;
a spray liquid flow passage 7 to the spray liquid nozzle, with the needle 6 extending in the spray liquid flow passage;
a flow-passage/needle seal 8 at a position along the needle spaced from the spray liquid nozzle;
a trigger mechanism 9 connected to the needle 6 to regulate its position;
an air cap 10 defining with the spray liquid nozzle:
a convergent air flow region 11 immediately upstream of the spray liquid orifice 3,
a central opening 12 from which spray liquid entraining air flows and
a pair of opposed horns 14,14;15,15—four air horns, i.e. two pairs, being provided—having spray patterning bores 16,17 with orifices directed inwards for patterning the spray liquid containing air flow from the central opening 12 and
an air distributor 18 upstream of the air cap 10 for distributing air to the patterning bores.

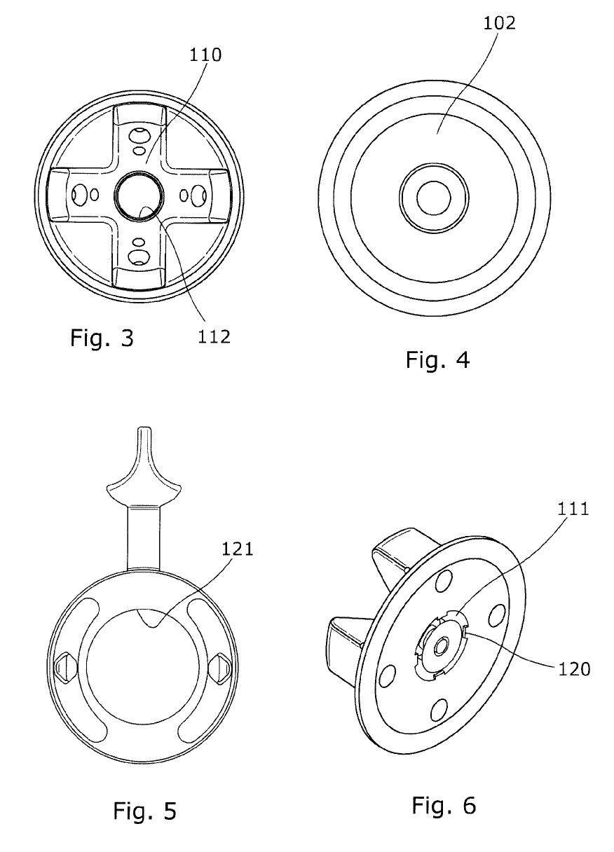

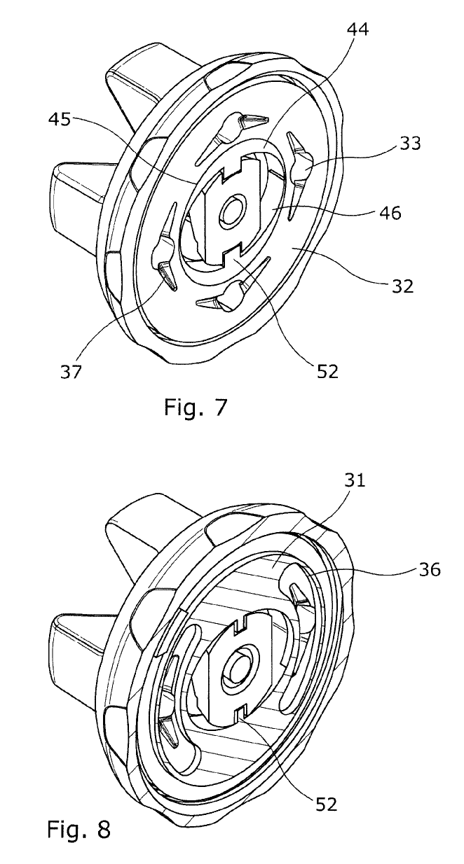

With reference to FIGS. 3 to 6, in the air spray gun of Our Earlier Patents, the central opening 112 of the air cap 110 is a circular bore and its convergent flow region 111 has four pips 120 extending inwards. The spray liquid nozzle 102 has a circularly conical front, which is in abutment with the pips 120, whereby the air cap and the nozzle are centred with respect to each other. The air distributor has a central bore 121, which also is a circular bore. Thus there is no feature of these components which biases the air flow in the central passageway towards or away from any one air horn or horns.

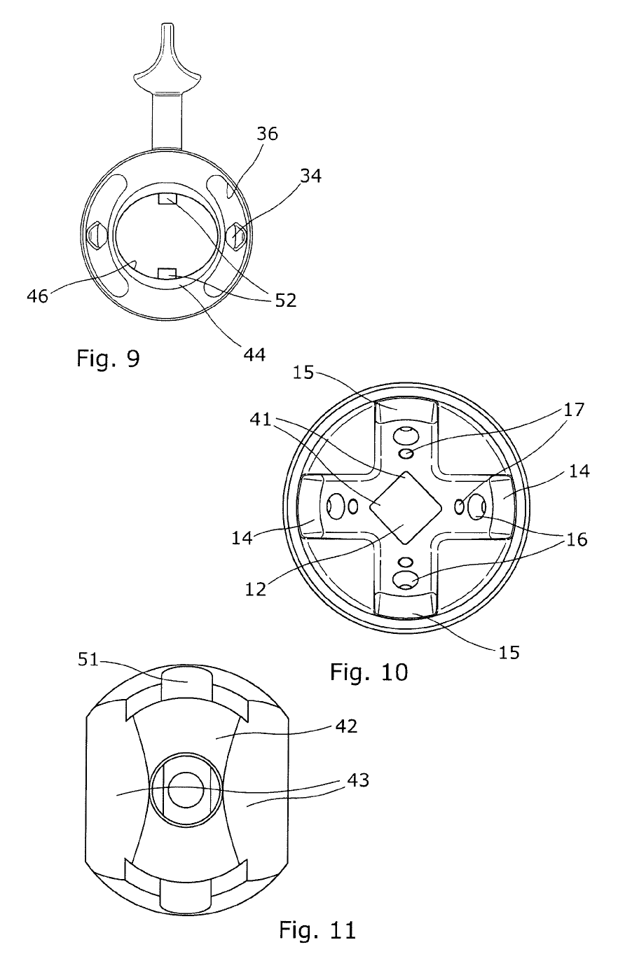

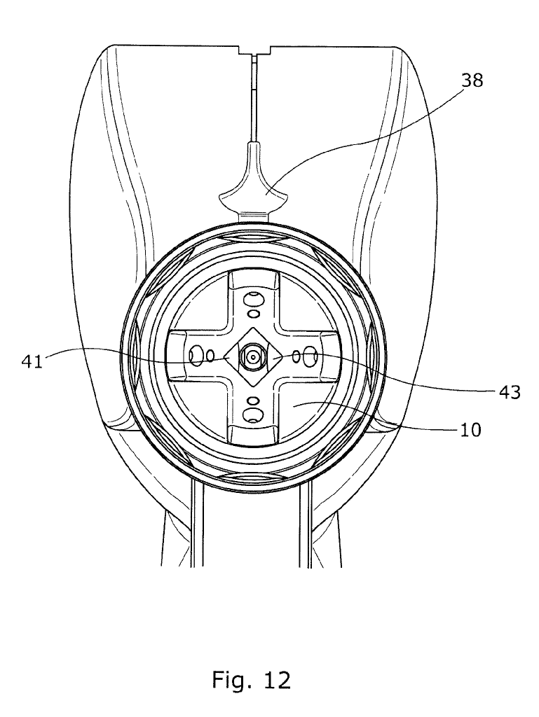

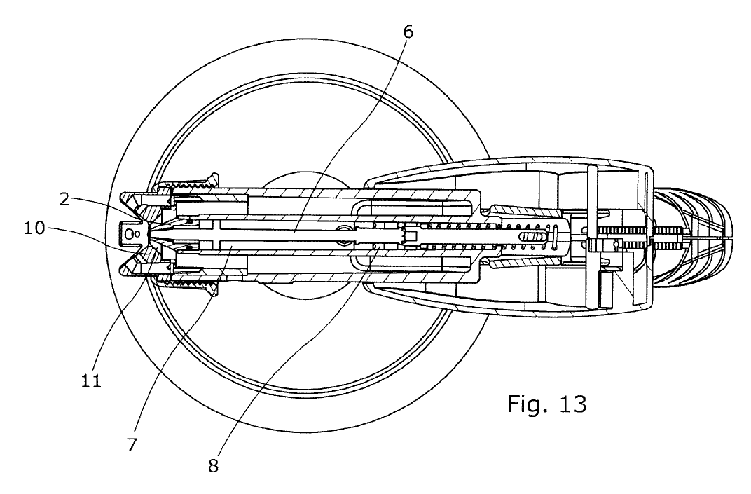

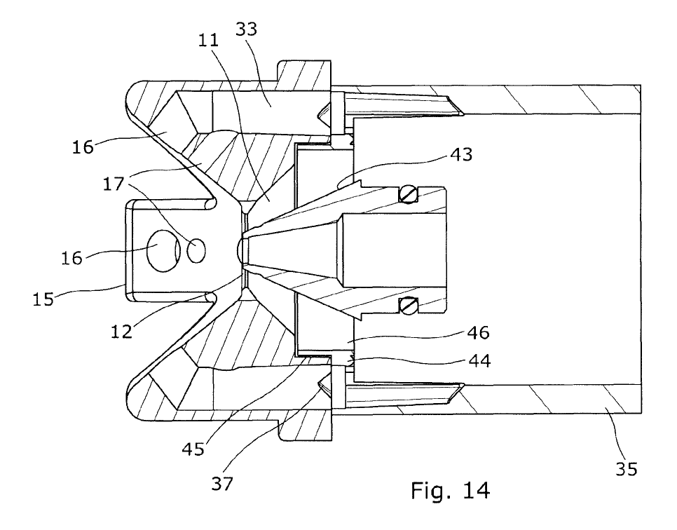

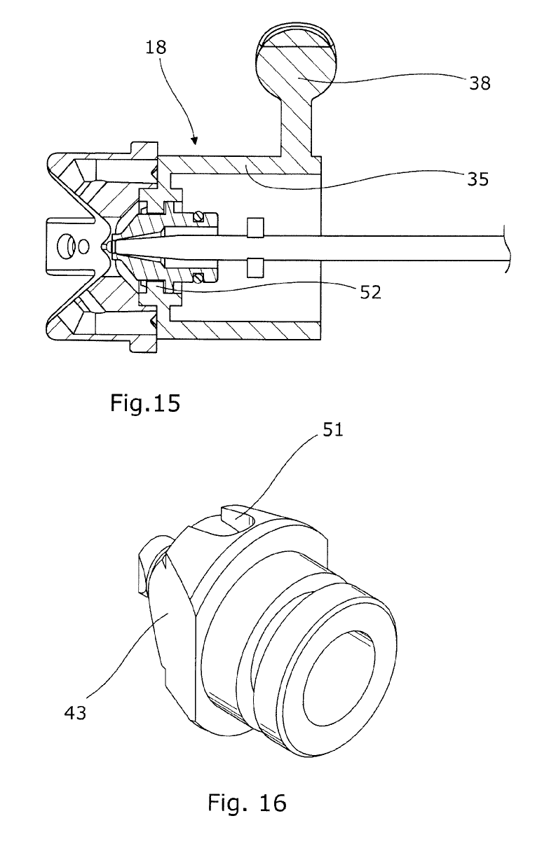

With reference to FIGS. 7 to 15 of the present invention, the purpose of the air distributor, both as in the air spray gun of Our Earlier Patents and in the present invention, is to direct air selectively to the air horns. For this purpose, it has a front flange 31, which abuts a rear face 32 of the air cap. The air cap has through bores 33 for providing patterning air flow from upstream in the air flow passage 1 via ports 34 in a rear sleeve 35 of the distributor. The front flange has quarter-circular circumferential grooves 36 which opens into the bores 33. The patterning bores 16,17 of the air horns open in the rear face of the air cap at circumferentially extended orifices 37. These communicate with the grooves 36 to a greater or lesser extent according to the position of the distributor set by its adjustment lug 38. The full details of this is explained in Our Earlier Patents and will not be elaborated on here. Suffice it to say only that one or other or both of the diametrically opposite pairs of air horns receives patterning air to an extent determined by the position of the lug.

In accordance with invention:
the central opening 12 of the air cap is radially biased towards the air horns.

In this preferred embodiment, the opening is substantially square with the corners 41 of the square pointing towards the air horns. The air cap is not adjustable in this gun. These corners, or at least the ones provided with more air as described below, bias the air flow through the central opening and its entrained spray liquid towards the patterning flow from the horns, whereby the patterning effect is enhanced;
the conical front 42 of the spray liquid nozzle is provided with convergent flats 43 on diametrically opposite sides of the nozzle, allowing more air flow to the ones of the corners providing air to the active air horns;
the air distributor is provided with a forwards collar 44 extending forwards centrally of the front flange 31. The collar engages in the rear orifice 45 of the air cap. The bore 46 of the collar is non-circular, being biased towards its bores 33, to further enhance the air flow through the operative corners 41. The bore can be elliptical.

An additional feature is the provision of grooves 51 in the nozzle between the flats 43 and pips 52 in the distributor bore 46. The pips engage in the grooves, whereby the nozzle is adjustably turned with the distributor.

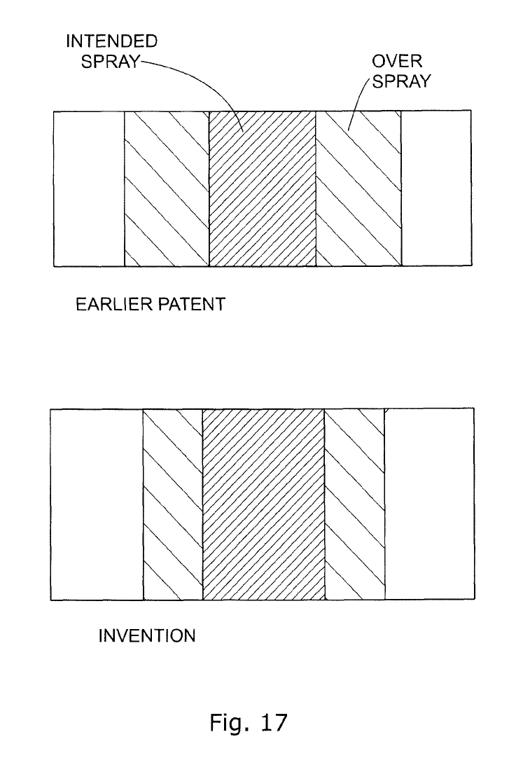

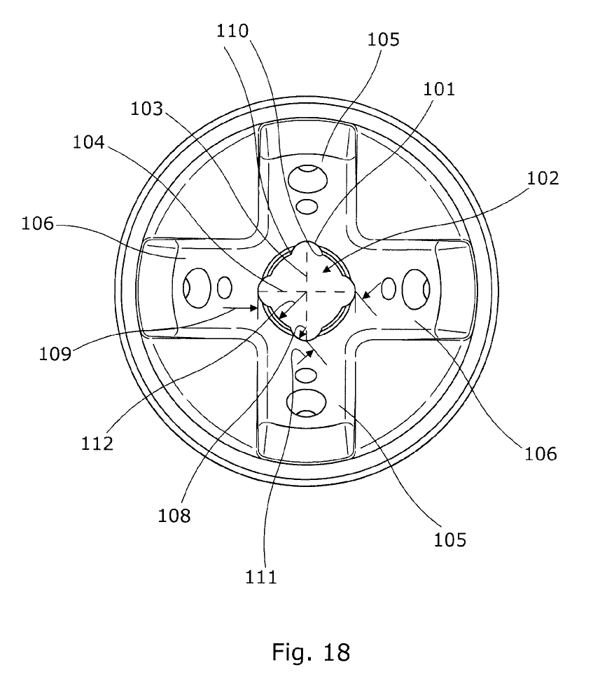

The result is the spray pattern is flattened to a greater extent than previously, but surprisingly with a more clearly defined edge and less over spray as shown in FIG. 17.

In the improvement of FIG. 18, the substantially-square, central opening of the air cap is replaced by a compound curved shape providing pronounced curvature of the corners 101 of the opening 102 at the axes 103,104 between opposed air horns 105,106.

The corners have a radius of curvature 108, typically 1.5 mm, and a dimension 109, typically 9 mm, on the axes which is the maximum transverse dimension of the opening. As shown, the radius of curvature is one sixth of that of the maximum transverse dimension. The sides of the opening do not extend tangential to the curved corners. Rather the corners curvature continues to points 110 spaced by approximately one third of the furthest separation 111 of the curvature of adjacent corners. The opening could be straight between the corners, but is preferably curved 112 with a radius typically 3.5 mm, centred at the centre of the opening and passing through the points 110.

We have found that this shape further improves paint spray patterning and discourages paint deposition on the air horns.

1. A spray gun comprising:
an air flow passage in the gun;
a spray liquid nozzle mounted in the air flow passage and having an orifice for spray liquid to flow from, the orifice being on the downstream side of the spray liquid nozzle with respect to both air and spray liquid flow;
a needle extending from upstream into the spray liquid nozzle for regulating its orifice and flow of the spray liquid;
a spray liquid flow passage to the spray liquid nozzle, with the needle to extending in the spray liquid flow passage;
a seal at a position along the needle spaced from the spray liquid nozzle;
a trigger mechanism connected to the needle to regulate its position;
an air cap, the air cap and spray liquid nozzle defining:
a convergent air flow region immediately upstream of the spray liquid orifice;
a central opening from which spray liquid entraining air flows; and
at least one pair of opposed horns having spray patterning bores with orifices directed inwards for patterning the spray liquid containing air flow from the central opening and
an air distributor upstream of the air cap for distributing air to the patterning bores
wherein the central opening in the air cap is provided with formations, so as to bias air flow towards the pair of air horns.

2. A spray gun as claimed in claim 1, wherein the air cap has two pairs of horns, rotationally fixed, and a rotationally adjustable air distributor.

3. A spray gun as claimed in claim 1, wherein the air cap has a single pair of rotationally adjustable air horns, and a fixed air distributor.

4. A spray gun as claimed in claim 1, wherein the air cap formations are spreadings of the central bore, the spreadings being diametrically aligned with the said air horns.

5. A spray gun as claimed in claim 5, wherein the spreadings are two sided cut-outs or nicks directed towards their air horns.

6. A spray gun as claimed in claim 1, wherein the spray liquid nozzle formations are external cutaways aligned or alignable with the said air horns.

7. A spray gun as claimed in claim 6, wherein the external cutaways are flats in the external conical surface of the nozzle.

8. A spray gun as claimed in claim 7, wherein the flats are scallops.

9. A spray gun as claimed in claim 1, wherein the air distributor bore formations are spreadings alignable with the said air horns.

10. A spray gun as claimed in claim 9, wherein the spreadings are local, curved enlargements of the diametrical dimension of the bore.

11. A spray gun as claimed in claim 10, wherein the spreadings give the bore an elliptical shape.

12. A spray gun as claimed in claim 1, wherein the air distributor and the spray liquid nozzle are rotationally connected whereby the nozzle cutaways and the air-distributor, bore spreadings are aligned.

13. A spray gun as claimed in claim 12, wherein the alignment is via grooves in the nozzle and spigots on the air distributor engaging in the grooves.

14. A spray gun as claimed in claim 1, wherein the spray gun is an HVLP air spray gun.

15. A spray gun as claimed in claim 1, wherein the air cap formations have a pronounced radius of curvature biasing the air flow towards the air horns.

16. A spray gun as claimed in claim 15, wherein the radius of curvature is between a fourth and an eighth of that of the transverse dimension of the central opening in the direction between opposed air horns.

17. A spray gun as claimed in claim 16, wherein the radius of curvature is substantially one sixth of this dimension.

18. A spray gun comprising:
an air flow passage in the gun;
a spray liquid nozzle mounted in the air flow passage and having an orifice for spray liquid to flow from, the orifice being on the downstream side of the spray liquid nozzle with respect to both air and spray liquid flow;
a needle extending from upstream into the spray liquid nozzle for regulating its orifice and flow of the spray liquid;
a spray liquid flow passage to the spray liquid nozzle, with the needle extending in the spray liquid flow passage;
a seal at a position along the needle spaced from the spray liquid nozzle;
a trigger mechanism connected to the needle to regulate its position;
an air cap, the air cap and spray liquid nozzle defining:
a convergent air flow region immediately upstream of the spray liquid orifice;
a central opening from which spray liquid entraining air flows; and
at least one pair of opposed horns having spray patterning bores with orifices directed inwards for patterning the spray liquid containing air flow from the central opening and
an air distributor upstream of the air cap for distributing air to the patterning bores
wherein an outer surface of the spray liquid nozzle, in its extent towards the central opening, is provided with formations, so as to bias air flow towards the pair of air horns.

19. A spray gun comprising:
an air flow passage in the gun;
a spray liquid nozzle mounted in the air flow passage and having an orifice for spray liquid to flow from, the orifice being on the downstream side of the spray liquid nozzle with respect to both air and spray liquid flow;
a needle extending from upstream into the spray liquid nozzle for regulating its orifice and flow of the spray liquid;
a spray liquid flow passage to the spray liquid nozzle, with the needle extending in the spray liquid flow passage;
a seal at a position along the needle spaced from the spray liquid nozzle;
a trigger mechanism connected to the needle to regulate its position;
an air cap, the air cap and spray liquid nozzle defining:
a convergent air flow region immediately upstream of the spray liquid orifice;
a central opening from which spray liquid entraining air flows; and
at least one pair of opposed horns having spray patterning bores with orifices directed inwards for patterning the spray liquid containing air flow from the central opening and
an air distributor upstream of the air cap for distributing air to the patterning bores
wherein a central bore in the air distributor is provided with formations, so as to bias air flow towards the pair of air horns.
